(19) United States
(12) Patent Application Publication
(10) Pub. No.: US 2017/0332096 A1
(43) Pub. Date: Nov. 16, 2017

(54) SYSTEM AND METHOD FOR DYNAMICALLY STITCHING VIDEO STREAMS

(71) Applicants: Advanced Micro Devices, Inc., Sunnyvale, CA (US); ATI TECHNOLOGIES ULC, Markham (CA)

(72) Inventors: Kismat Singh, Austin, TX (US); Kadagattur Gopinatha Srinidhi, Bangalore (IN); Mark Chan, Markham (CA); Neelakanth Devappa Shigihalli, Bangalore (IN); Kishor Kayyar Lakshminarayana, Bangalore (IN)

(21) Appl. No.: 15/170,103

(22) Filed: Jun. 1, 2016

(30) Foreign Application Priority Data
May 11, 2016 (IN) 201641016496

(51) Int. Cl. H04N 19/52; H04N 19/182; H04N 19/176; H04N 19/184; H04N 19/172

(52) U.S. Cl. CPC H04N 19/52; H04N 19/184; H04N 19/172; H04N 19/176; H04N 19/182

(57) ABSTRACT

A video codec includes a stitching module configured to select stored encoded video frames that are to be composed into a concatenated frame for display. The stitching module arranges the selected encoded video frames into a specified pattern, and stitches the arranged encoded video frames together to generate a stitched encoded frame. A decoder of the video codec then decodes the stitched encoded frame to generate the frame for display. By stitching together the encoded video frames prior to decoding, the video codec reduces the number of times the decoder must be initialized,

### BACKGROUND

### Field of the Disclosure

The present disclosure relates generally to video processing and more particularly to video decoding.

### Description of the Related Art

Video encoders and decoders are used in a wide variety of applications to facilitate the storage and transfer of video streams in a compressed fashion. For example, a video stream can be encoded prior to being stored at a memory in order to reduce the amount of space required to store the video stream, then later decoded in order to generate frames for display at a display device. Typically, prior to decoding a video stream the decoder must be initialized in order to prepare memory and other system resources for the decoding process. However, the overhead required to initialize the decoder can significantly impact the efficiency of the decoding process, especially in applications that require decoding of many different video streams.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a video codec configured to stitch together encoded video frames to generate a stitched encoded frame for decoding in accordance with some embodiments.

FIG. 2 is a block diagram of an example of the video codec of FIG. 1 stitching a set of encoded video frames to generate a stitched encoded frame in accordance with some embodiments.

FIG. 3 is a block diagram of an example of the video codec of FIG. 1 selecting and stitching different sets of encoded video frames to generate different stitched encoded frames in accordance with some embodiments.

FIG. 4 is a block diagram of an example of the video codec of FIG. 1 selecting and stitching different sets of encoded video frames to generate different stitched encoded frames comprised of overlapping encoded video frames in accordance with some embodiments.

FIG. 5 is a block diagram of an example of the video codec of FIG. 1 modifying a header of an encoded video frame to determine the order in which it will be stitched into a stitched encoded frame and generate other video headers in accordance with some embodiments.

FIG. 6 is a flow chart of a method of stitching together encoded video frames to generate a stitched encoded frame for decoding in accordance with some embodiments.

### DETAILED DESCRIPTION

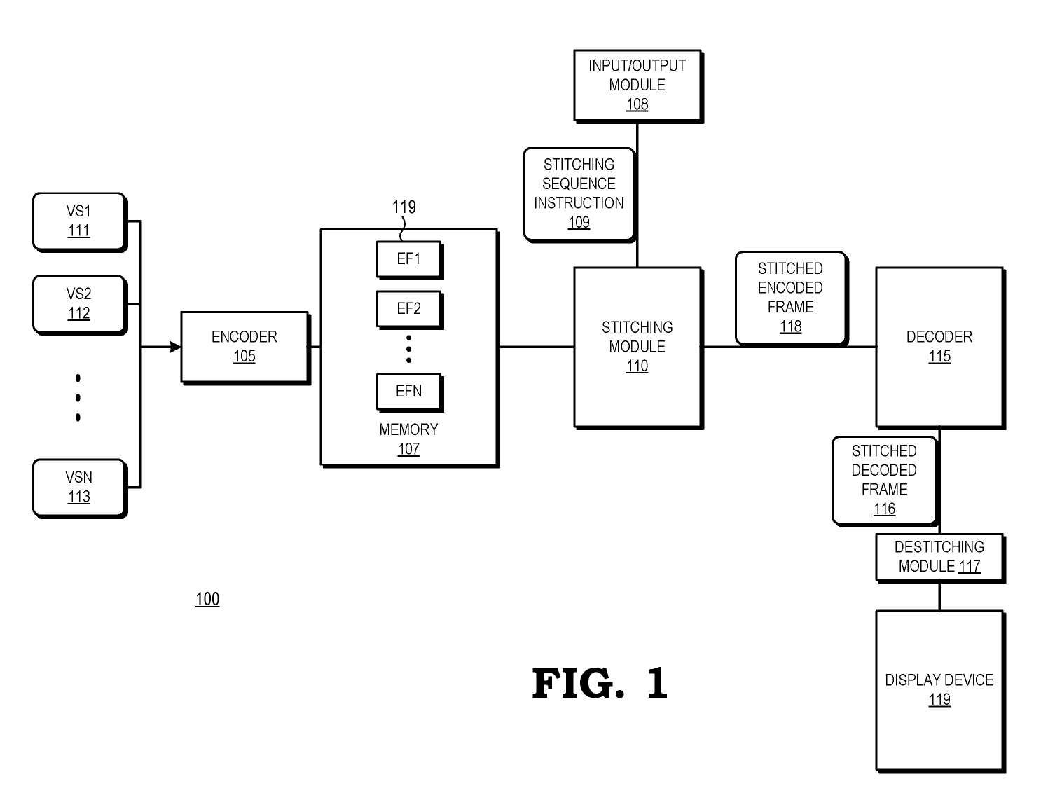

FIGS. 1-6 illustrate techniques for reducing initialization overhead at a video codec by stitching independently encoded video frames to generate stitched encoded frames for decoding. The video codec includes a stitching module configured to select stored encoded video frames that are to be composed into a concatenated frame for display. The stitching module arranges the selected encoded video frames into a specified pattern, and stitches the arranged encoded video frames together to generate a stitched encoded frame. A decoder of the video codec then decodes the stitched encoded frame to generate the frame for display. By stitching together the encoded video frames prior to decoding, the video codec reduces the number of times the decoder must be initialized, thereby improving processing efficiency.

To illustrate, in order to decode a video frame the decoder must be initialized by, for example allocating memory for decoding, preparing buffers and other storage elements, flushing data stored during previous decoding operations, and the like. The amount of overhead required to initialize the decoder (referred to herein as the “initialization overhead”) is typically independent of the size of the video to be decoded. Accordingly, for some types of devices that generate display frames composed from many independent video streams, the initialization overhead can have a significant impact on codec resources and performance. This is particularly the case where the video streams are relatively small in resolution. For example, in casino gaming and Pachinko/Pachislot devices, each display frame is composed of many independent video streams, where the video streams to be displayed can change frequently over time. Conventionally, the different independent video streams are encoded and decoded independently, and then composed into the frame for display. This approach requires the decoder to be re-initialized for each independent video stream and at every frame level, such that the initialization overhead consumes an undesirable amount of system resources. Using the techniques described herein, a video codec can dynamically stitch selected multiple encoded frames into a single stitched encoded frame for decoding. This supports decoding a large number of possible combinations of a large number of possible video frames without requiring excessive memory or decoder initialization overhead. Further, by dynamically stitching selected encoded frames into stitched frames for decoding, the number of initializations of the decoder is reduced.

FIG. 1 illustrates an example of a video codec 100 configured to encode and decode video streams to generate frames for display at an electronic device in accordance with some embodiments. As such, the video codec 100 can be employed in any of a variety of devices, such as a personal computer, mobile device such as a smartphone, a video player, a video game console, a casino gaming device and the like. As described further herein, the video streams encoded by the video codec 100 are comprised of a plurality of images or pictures for display at a display device 119. Because the large amount of information stored in each video stream can require considerable computing resources such as processing power and memory, the video codec 100 is employed to encode or compress the information in the video streams without unduly diminishing image quality. Prior to display, the video codec decodes so that the uncompressed images in the video streams can be displayed at a display device.

To support encoding and decoding of video streams, the video codec 100 comprises an encoder 105, a memory 107, an input/output module 108, a stitching module 110, a decoder 115, a destitching module 117, and a display device 119. The encoder 105 is configured to receive video streams (VS), including VS1 111, VS2 112 through an Nth video stream VSN 113. The encoder 105 is further configured to encode each received video stream to generate a corresponding stream of encoded frames (e.g., stream of encoded frames (EF) 119 corresponding to VS1 111). Each of the video streams 111-113 represents a different sequence of video frames, and can therefore represent any of a variety of video content items. For example, in some embodiments, each video stream represents an animation of a gaming element of a casino game, such as video slot machine or pachinko machine. In some embodiments, each video stream represents a different television program, movie, or other video entertainment content.

The encoder 105 is configured to encode each received video stream 111-113 according to one of any of a number of compression or encoding formats or standards, such as Motion Picture Expert Group (MPEG)-2 Part 2, MPEG-4 Part 2, H.264, H.265 (HEVC), Theora, Dirac, RealVideo RV40, VP8, or VP9 encoding formats, to generate a corresponding encoded video stream. The encoder outputs the corresponding encoded video frames EF1, EF2 . . . EFN to memory 107. These encoded frames are comprised of encoded macroblocks or coding tree units (CTUs).

Memory 107 is a storage medium generally configured to receive the encoded video frames EF1, EF2 . . . EFN from encoder 105 and store them for retrieval by stitching module 110. As such, memory 107 may include any storage medium, or combination of storage media, accessible by a computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. Memory 107 may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Input/output module 108 is generally configured to generate electrical signals representing a user's interaction with an input device (not shown), such as a touchscreen, keyboard, a set of buttons or other input, game controller, computer mouse, trackball, pointing device, paddle, knob, eye gaze tracker, digital camera, microphone, joystick and the like. For purposes of description, it is assumed that the user's interaction with the input device results in a selection of video streams for display. In some embodiments the selection may be a direct selection, whereby the user selects particular video streams for display. For example, the user may employ a mouse or television remote control to select an arrangement of video clips to be simultaneously displayed. In other embodiments, the selection can be an indirect selection, such as a random selection of video frames generated in response to a user input. For example, the selection can be a random selection of video streams generated in response to a user pressing a “spin” button at a casino gaming machine.

Based on the user selection, the input/output module 108 generates stitching sequence instruction 109 to indicate both the individual video streams to be displayed, and the arrangement of the video streams as they are to be displayed. For example, the input/output module 108 may be programmed to generate, based on received user inputs, stitching sequence instructions 109 that delineate a random or pseudo-random selection of video streams and the arrangement of the video streams as they are to be displayed. Thus, in one scenario the input/output module 108 may generate stitching instruction 109 directing the selection of encoded frames EF2, EF4 (not shown), EF5 (not shown), and EF8 (not shown), and the arrangement of the corresponding video stream in a one-dimensional stack, with the video stream represented by encoded frame EF2 to be displayed at the top of the stack, the video stream represented by encoded frame EF4 to be displayed below encoded frame EF2, the video stream represented by encoded frame EF5 to be displayed below encoded frame EF4, and the video stream represented by encoded frame EF8 to be displayed below encoded frame EF5, at the bottom of the stack.

It will be appreciated that the input/output module 108 can change the stitching instructions 109 to reflect new user input and new corresponding selections and arrangements of video frames to be displayed. For example, in the case of a casino gaming machine, for each user input representing a spin or other game event, the input/output module 108 can generate new stitching instructions 109, thereby generating new selections and arrangements of the video frames according to the rules of the casino game.

The stitching module 110 is configured to receive the stitching sequence instructions 109 and, in accordance with the stitching sequence instructions 109, selects encoded frames stored in memory 107 and stitches the encoded frames to generate a stitched encoded frame 118 for output to decoder 115. Each of the independent encoded frames becomes a portion of the stitched encoded frame 118. In some embodiments, and as described further herein, stitching module 110 stitches the selected encoded frames by modifying the pixel block headers (e.g., macroblock or CTU headers) of the selected encoded frames, such as by modifying a sequence number of the pixel block header that indicates the location of the corresponding pixel block in the frame to be displayed.

The decoder 115 is generally configured to decode the stitched encoded frame 118 from stitching module 110 to generate a decoded frame 116. Decoder 115 decodes the stitched encoded frame 118 according to any of a number of decompression or decoding formats or standards, and corresponding to the format or standard with which the video streams were encoded by the encoder 105. The decoder 115 then provides the decoded frame 116 to the destitching module 117. Because the decoded frame 116 is generated based on the stitched encoded frame 118, it corresponds to a frame that would be generated if each of the individual displayed video streams were composited prior to encoding. However, by stitching together the video streams in their encoded form, the video codec 100 supports a wide variety of video stream selection and arrangement combinations while reducing setup overhead. Because the encoded video frames have been selected and stitched into a stitched encoded frame by the stitching module 110, decoder 115 needs to be setup only once per frame to decode the stitched encoded frame 118 rather than re-setup for each encoded video frame EF1 to EFn, even though the encoded video frames and their arrangement within the stitched frame were not determined until after the individual video frames were encoded.

Destitching module 117 is generally configured to receive de-stitching instructions (not shown) and, in accordance with the de-stitching instructions, de-stitch the stitched decoded frame 116 to generate decoded (uncompressed) video streams corresponding to VS1 111, VS2 112, . . . VSN 113. The destitching module 117 outputs the decoded video streams (not shown), which are composed by the display device 119 to generate a display frame for display on the display device 119.

To illustrate, in operation, encoder 105 receives video streams 111-113, encodes each received stream to generate corresponding encoded video frames, and stores the encoded video frames at the memory 107. In at least one embodiment, the encoding of the video streams into the encoded video frames is done prior to general operation of a device that employs the video codec 100. For example, the encoded video frames may be generated by the encoder 105 during a manufacturing or provisioning stage of the device employing the video codec 100 so that the encoded video frames are ready during general operation of the device by a user.

The user interacts with the device via input/output module 108 which, in response to the user interactions, generates the stitching sequence instructions 109. Based on the stitching sequence instructions 109, stitching module 110 selects encoded frames stored in memory 107 and stitches the encoded frames to generate a stitched encoded frame 118 for output to decoder 115. The decoder decodes received stitched encoded frame 118 to generate stitched decoded frame 116 for output to destitching module 117. Destitching module 117 destitches received stitched decoded frame 116 to generate decoded video streams for output to display device 119, which displays the video streams to the user.

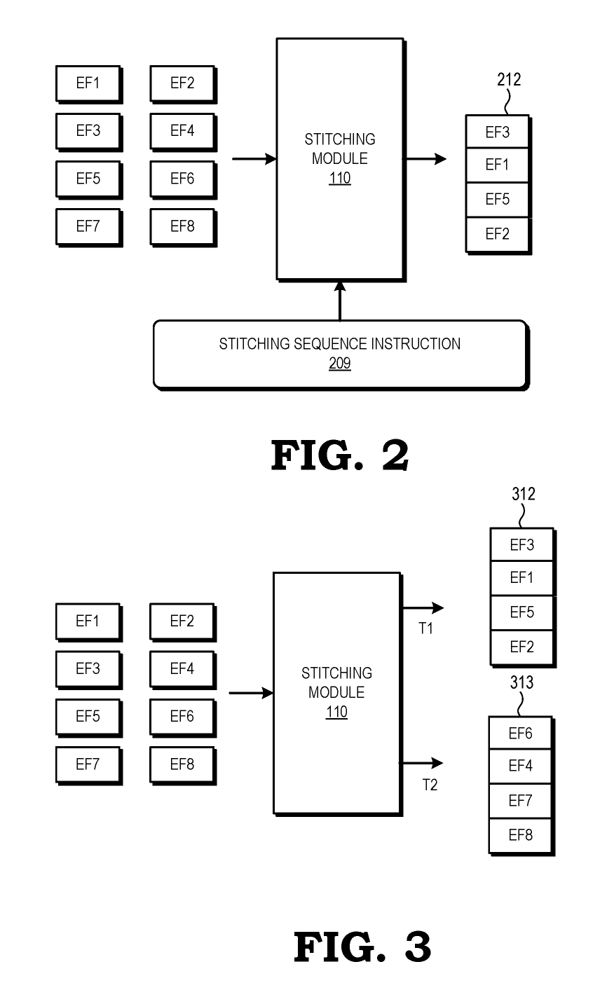

FIG. 2 illustrates an example of the video codec 100 generating a stitched encoded frame 212 in accordance with some embodiments. In the illustrated example, encoded video frames EF1, EF2, EF3, EF4, EF5, EF6, EF7 and EF8 are stored in memory 207 (not shown). Stitching module 110 receives stitching sequence instruction 209. For purposes of the illustrated example, it is assumed that the stitching sequence instruction 209 indicates that the encoded video frames EF1, EF2, EF3, and EF5 are to be arranged in a one-dimensional stack, with EF3 in at the top of the stack, EF1 below EF3, EF5 below EF1, and EF2 below EF5, at the bottom of the stack.

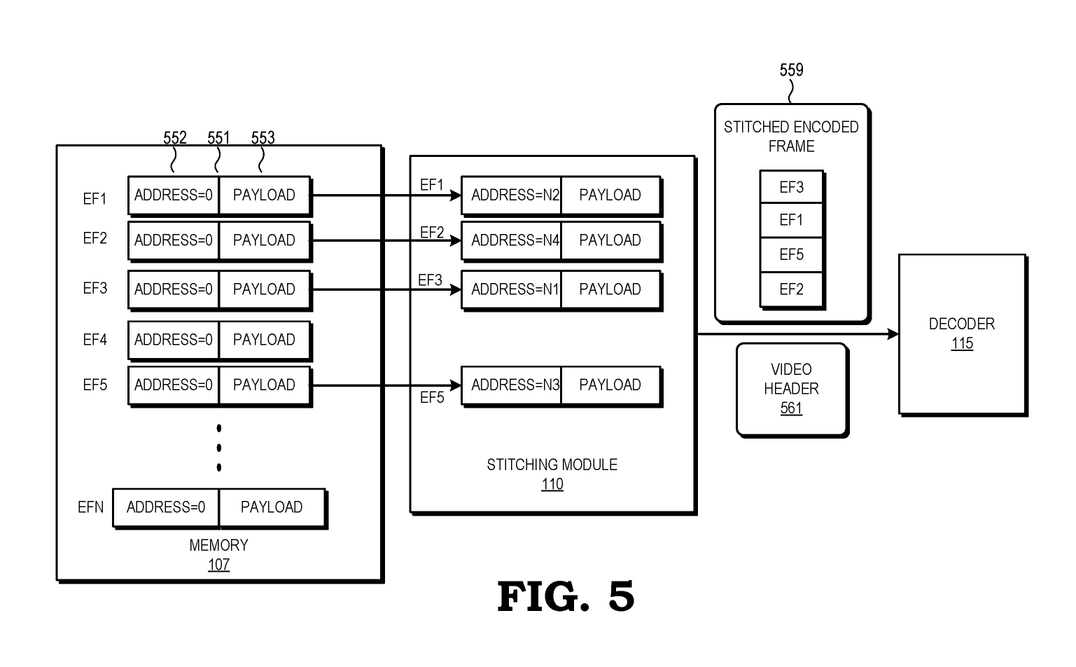

In response to receiving the stitching sequence instruction 209, stitching module 110 retrieves encoded video frames EF1, EF2, EF3 and EF5 from the memory 207, and stitches them into a stitched encoded video frame 212 having four vertically-stacked encoded video frames, with EF3 at the top of the stack, EF1 below EF3, EF5 below EF1, and EF2 below EF5, at the bottom of the stack. The stitching module 110 thus matches the selection and arrangement indicated by the stitching sequence 109. In some embodiments, the stitching module 110 arranges the selected encoded frames according to the instructed arrangement by modifying one or more pixel block headers of the encoded frames, thereby modifying the location of the corresponding pixel blocks in the frame. An example is described further below with respect to FIG. 5.

In some embodiments, the stitching sequence instruction received by the stitching module 110 can change over time in response to user inputs, thereby generating different stitched arrangements of encoded video frames into different encoded stitched frames at different times. An example is illustrated at FIG. 3 in accordance with some embodiments. In the illustrated example, encoded video frames EF1, EF2, EF3, EF4, EF5, EF6, EF7 and EF8 are stored in memory 107. At time T1, stitching module 110 receives a stitching sequence instruction (not illustrated) indicating that the encoded video frames EF1, EF2, EF3, and EF5 are to be arranged in a stack having four frames, with EF3 at the top of the stack, EF1 below EF3, EF5 below EF1, and EF2 below EF5, at the bottom of the stack. In accordance with received stitching sequence instruction, stitching module 110 retrieves encoded video frames EF1, EF2, EF3, and EF5, and stitches them into an encoded video frame 312 having four stacked frames, with EF3 at the top of the stack, EF1 below EF3, EF5 below EF1, and EF2 below EF5, at the bottom of the stack.

At time T2 after time T1, stitching module 110 receives a new stitching sequence instruction (not shown) indicating that the encoded video frames EF4, EF6, EF7, and EF8 are to be arranged in a stack having four frames, with EF6 at the top of the stack, EF4 below EF6, EF7 below EF4, and EF8 below EF7, at the bottom of the stack. In accordance with received stitching sequence instruction, stitching module 110 retrieves encoded video frames EF4, EF6, EF7, and EF8, and stitches them into an encoded video frame 313 having four vertically-stacked frames, with EF6 at the top of the stack, EF4 below EF6, EF7 below EF4, and EF8 below EF7, at the bottom of the stack. Thus, in the example of FIG. 3 the stitching module 103 updates the selection and arrangement of encoded video frames in response to changes in the stitching sequence instruction, thereby changing the arrangement of video streams displayed at the display device 117.

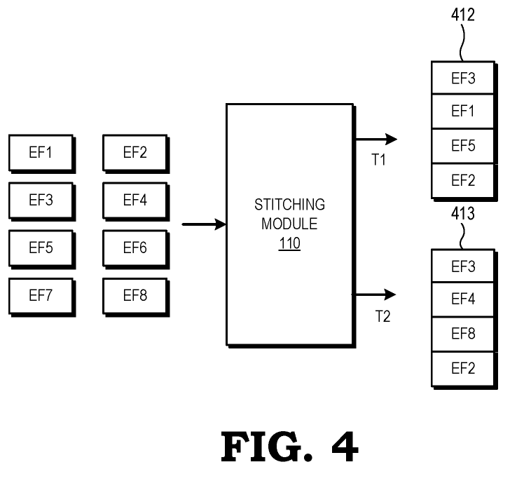

FIG. 4 illustrates an example of the video codec of FIG. 1 selecting and stitching different sets of encoded video frames to generate different stitched encoded frames comprised of overlapping sets of encoded video frames in accordance with some embodiments. In the depicted example, encoded video frames EF1, EF2, EF3, EF4, EF5, EF6, EF7 and EF8 are stored in memory 107. At time T1, stitching module 110 receives stitching sequence instruction (not shown). In accordance with received stitching sequence instruction, stitching module 110 retrieves encoded video frames EF1, EF2, EF3, and EF5, and stitches them into an encoded video frame 412 having four stacked frames, with EF3 at the top of the stack, EF1 below EF3, EF5 below EF1, and EF2 below EF5, at the bottom of the stack. At time T2, stitching module 110 receives a new stitching sequence instruction (not shown). In accordance with received stitching sequence instruction (not shown), stitching module 110 retrieves encoded video frames EF2, EF3, EF4, and EF8, and stitches them into an encoded video frame 413 having four stacked frames, with EF3 at the top of the stack, EF4 below EF3, EF8 below EF4, and EF2 below EF8, at the bottom of the stack.

FIG. 5 illustrates an example of the video codec of FIG. 1 modifying a pixel block identifier (e.g., a macroblock or CTU header) of an encoded video frame to determine the order in which it will be stitched into a stitched encoded frame 559 in accordance with some embodiments. In the depicted example the memory 107 stores encoded video frames such as encoded video frame 551. Each encoded video frame is comprised of at least a header and a payload (e.g., header 552 and payload 553 for encoded frame 551). The header includes address information for the specified pixel block of the encoded video frame. For example, the address of the first pixel block, located in the upper left corner of the pixel block can be designated 0. By changing the address information in the pixel block header, the stitching module 110 changes the positions of the pixel blocks in the stitched frame. For example, by changing the address in the pixel block header from 0 to 2, the stitching module 110 shifts the pixel block two positions down, assuming four pixel blocks per stitched encoded frame, and a stitched encoded frame having four stacked pixel blocks. Changing the address in the pixel block header from 0 to 8 shifts the pixel block eight positions down.

In the depicted example, stitching sequence instruction (not shown) indicates that encoded video frame EF3 is to be stitched into the top of the stitched encoded frame 559, encoded video frame EF1 is to be stitched below encoded video frame EF3, encoded video frame EF5 is to be stitched below encoded video frame EF1, and encoded video frame EF2 is to be stitched below encoded video frame EF5, at the bottom of the stitched encoded frame 559. Accordingly, stitching module 110 modifies the pixel block header address of encoded video frame EF3 from 0 to N1; modifies the pixel block address of encoded video frame EF1 from 0 to N2, the pixel block address of encoded video frame EF5 from 0 to N3 and the address of encoded video frame EF2 from 0 to N4. In this example, it is assumed that address N4 is shifted more than N3 which is shifted more than N3 which is shifted more than N1, in order to achieve the arrangement shown in stitched encoded frame 559. Persons of skill can appreciate that other relative shifts in addresses can be used in other implementations to achieve the same ordering. The stitching module 110 thus changes the relative position of the pixel blocks of each encoded video frame for the stitched encoded frame 559, thereby logically stitching the encoded frames into the stitched encoded frame 559. In some embodiments, in order to ensure correct decoding according to the relevant codec standard, the stitching module 110 changes the pixel block headers without changing the number of bits that store the address information.

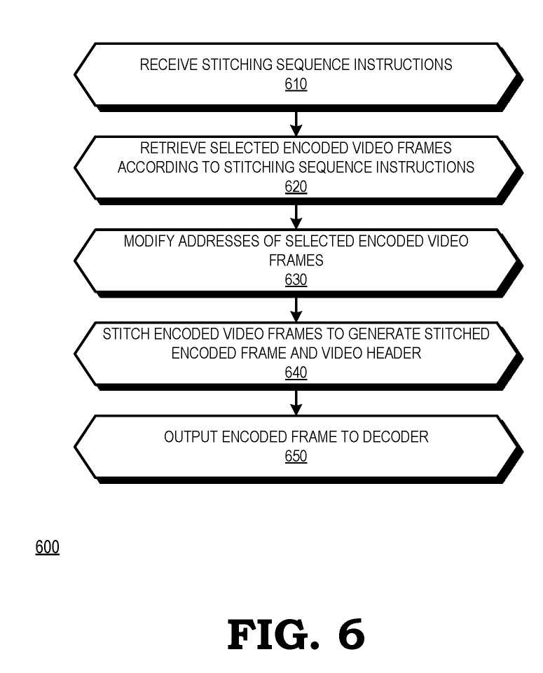

FIG. 6 illustrates a method 600 of stitching together encoded video frames to generate a stitched encoded frame for decoding in accordance with some embodiments. At block 610, the stitching module 110 receives stitching sequence instruction 109 from the input/output module. At block 620, the stitching module 110 retrieves selected encoded video frames from memory according to the received stitching instruction 109. At block 630, the stitching module modifies the pixel block header addresses of the selected encoded video frames according to the received stitching instruction 109. At block 640, the stitching module 110 stitches the encoded video frames according to the received stitching instruction 109 to generate a stitched encoded frame. At block 650, the stitching module 110 outputs the stitched encoded frame 117 to the decoder 115.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
stitching at a decoder a first plurality of received encoded video frames to generate a first combined plurality of encoded frames; and
decoding the first combined plurality of encoded frames to generate a first plurality of display frames.

2. The method of claim 1, further comprising:
stitching at the decoder a second plurality of received encoded video frames to generate a second combined plurality of encoded frames, the second plurality of received encoded video frames different from the first plurality of encoded video frames; and
decoding the second combined plurality of encoded frames to generate a second plurality of display frames.

3. The method of claim 2, wherein the second plurality of video frames includes at least one video frame of the first plurality of video frames.

4. The method of claim 2, further comprising:
selecting the first plurality of encoded video frames from a stored set of encoded video frames at a first time; and
selecting the second plurality of encoded video frames from the stored set of encoded video frames at a second time.

5. The method of claim 1, wherein stitching comprises:
modifying a pixel block address in a header of video frames of the first plurality of video frames.

6. The method of claim 5, wherein modifying the pixel block address comprises maintaining a number of bits of the pixel block address.

7. The method of claim 1, further comprising:
setting up the decoder to decode all of the first combined plurality of encoded frames.

8. The method of claim 1, wherein stitching comprises stitching a first plurality of encoded video frames, each encoded video frame having been encoded independently.

9. A method, comprising:
receiving a plurality of encoded video frames;
concatenating a selected subset of the plurality of encoded video frames to generate encoded frames; and
decoding the encoded frames to generate frames for display.

10. The method of claim 9, wherein concatenating comprises:
modifying a pixel block address of a first pixel block of the selected subset.

11. The method of claim 10, wherein concatenating further comprises:
modifying a pixel block address of a second pixel block of the selected subset.

12. The method of claim 11, wherein modifying the pixel block address comprises maintaining a number of bits of the pixel block address.

13. A device, comprising:
a stitching module configured to receive a first plurality of encoded video frames to generate a first combined plurality of encoded video frames; and
a decoder configured to decode the first combined plurality of encoded video frames to generate a first combined plurality of decoded video frames.

14. The device of claim 13, further comprising:
an input/output module configured to receive a user input and generate stitching sequence instructions based at least in part on the received user input.

15. The device of claim 14, wherein the stitching module is to receive a second plurality of encoded video frames.

16. The device of claim 15, wherein the stitching module is to:
select the first plurality of encoded video frames from a stored set of encoded video frames at a first time; and
select the second plurality of encoded video frames from the stored set of encoded video frames at a second time.

17. The device of claim 13, wherein the stitching module is to stitch the first plurality of encoded video frames by:
modifying a pixel block address in a header of a first video frame of the first plurality of video frames.

18. The device of claim 17, wherein the stitching module is to modify the pixel block address by maintaining a number of bits of the pixel block address.

19. The device of claim 13, wherein the decoder is to:
setup the decoder to decode all of the combined encoded frames.

20. The device of claim 13, further comprising:
a destitching module to destitch the combined decoded frames.
